(19) United States
(12) Patent Application Publication
(10) Pub. No.: US 2005/0276906 A1
(43) Pub. Date: Dec. 15, 2005

(54) Systems and methods for detecting and verifying taggant information of a tagged item or substance

(76) Inventor: Gary Metzger, Huntington Station, NY (US)

Correspondence Address: FISH & NEAVE IP GROUP;ROPES & GRAY LLP, 1251 AVENUE OF THE AMERICAS FL C3, NEW YORK, NY, 10020-1105, US

(21) Appl. No.: 10/866,651

(22) Filed: Jun. 10, 2004

(51) Int. Cl. B41M 3/14

(52) U.S. Cl. 427/7; 427/8

(57) ABSTRACT

Systems and methods are provided for tagging items using one or more taggant additives. Taggant additives may include microparticles or pigments. The taggant additives may be embedded in or affixed to an item. A tagged item may be interrogated using one of more types of radiation or other energy. That radiation or other energy emission may stimulate one or more of the taggant additives, and the stimulated taggant additives may emit radiation or other energy. A detection device may be used to detect the radiation or energy emissions, and taggant information based on the detected emissions may be recorded in a database. A verification device may later be used to detect radiation or energy emissions from stimulated taggant additives by comparing detected taggant information with the authentic taggant information recorded in the database. If a match is found then the item may be identified as authentic.

### BACKGROUND OF THE INVENTION

The present invention relates to systems and methods for tagging an item or substance and identifying and verifying or validating the authenticity of a tagged item or substance. More particularly, the present invention relates to systems and methods for detecting information about one or more taggant additives embedded in, or affixed to, an item or a substance used to make an item, recording taggant information in a database, and verifying or validating the authenticity of a tagged item based on the recorded taggant information.

The identification and verification of items is important for security purposes and to decrease the number of counterfeit items introduced to the marketplace. The identification and verification of items is also important for inventory and registration of items. Techniques for identifying and verifying items range from affixing or printing tagged labels onto a finished manufactured item to embedding a tag, observable at the surface (either under visible light or some other type of energy or radiation), into an item.

More sophisticated tags include laser tagging of precious stones, where a laser is used to alter a minute portion of the crystal structure of the stone that is not visible by the human eye, but is detectable with a reading device or magnifying lens. Other techniques for tagging items include using microparticle or pigment “taggants” that are embedded in or affixed to an item or substance. In one method, pigments which are not visible in visible light are applied to materials, and the presence (or absence) of the pigment is revealed by observing the item under radiation from another part of the spectrum—e.g., ultraviolet, infrared, etc. where the pigment becomes visible by, e.g., fluorescence, reflectivity, etc. Other methods include implanting in an item or substance microscopic particles that can be detected optically, but which are undetectable by the naked eye.

According to another known technique, an item may be recognized and identified based on an ultrasonic interrogation of the item to detect natural microfeatures of the item in order to generate an item “fingerprint” and then to identify the item by detecting that fingerprint.

Another known technique exists in which an isotopic taggant composition is used, and a tagged item or substance is identified by measuring the abundance ratio of isotopes.

According to other known methods, a controlled concentration of taggants provides a code that identifies a number of tagged items. A sample item assumed to have a taggant concentration representative of the remaining items is used as a control by which to verify the authenticity of the remaining items.

Known taggant materials may include a combination of at least one fluorophore and at least one luminescent nanoparticle. Such taggant materials may have a temperature stability of at least 350° C. and are used in a sufficient quantity as to be detectible using a spectrofluorometer.

It is further known to use taggant compositions that are based on a binary code. In such a method, microparticles are used to mark an item, and the microparticle composition of a taggant is based on a predetermined binary code sequence (which uses “0” and “1” to indicate whether a particular microparticle should be present in the coded taggant).

These known techniques, however, do not use taggant additives to precisely identify an individual item based on the individual item's taggant information. Accordingly these techniques fail to reliably distinguish a particular item from other items, or to identify and verify the authenticity of each item based on each item's particular taggant information.

It would therefore be desirable to use taggant additives to distinctly identify a particular tagged item and, therefore, to verify a tagged item's authenticity in a more precise and reliable manner.

### SUMMARY OF THE INVENTION

It is therefore an object of the present invention to use taggant additives to distinctly identify a particular tagged item and, therefore, to verify or validate a tagged item's authenticity in a more precise and reliable manner.

These and other objects are accomplished in accordance with the present invention by providing systems and methods for interrogating a tagged item using energy emissions to stimulate one or more taggant additives embedded in or affixed to an item. A tagged item may include a random distribution of one or more taggant additives (e.g., microparticles including but not limited to polarized particles, pigments, dyes, etc.) embedded in the tagged item. In another approach, a tagged label having one or more randomly distributed taggant additives may be affixed to an item using a label adhesive.

One or more energy emissions (e.g., electromagnetic radiation or other forms of electromagnetic energy such as a magnetic field) may be used to stimulate one or more taggant additives. The one or more stimulated taggant additives may emit radiation or other energy, which may be detected using a detection device. The radiation or energy emissions provide information about the taggant additives (“taggant information”), that preferably is unique for each particular tagged item. Taggant information may include, for example, the spatial arrangement of taggant additives embedded in, or affixed to, the tagged item. Taggant information may also include information about radiation or energy emissions emitted by the stimulated taggant additives (e.g., the intensity of the radiation or energy emissions, the polarization of the radiation or energy emissions, angles associated with the radiation or energy emissions including but not limited to angles of reflection or refraction, reflectivity as indicated by the radiation or energy emissions, index of refraction as indicated by the radiation or energy emissions, etc.). Radiation or other energy may be emitted by, e.g., fluorescence, reflection, refraction, etc.

Taggant information may be recorded in a database and later used to distinctly identify a tagged item or to verify the authenticity of a tagged item. Because the arrangement of the one or more taggant additives is the result of a random distribution of taggant additives, this information will be distinct for each tagged item and will be substantially impossible to duplicate. The recorded taggant information may be associated with an item identifier, which may be used as a database key to query the database of recorded taggant information. The item identifier may be printed on or affixed to the tagged item in a human-readable alphanumeric format (e.g., a serial number) or a machine-readable format (e.g., a bar code, a radio frequency identification device, etc.).

When it is desirable to identify a tagged item or to verify the authenticity of a tagged item, one or more energy emissions may be used to stimulate the one or more taggant additives. Radiation or other energy emitted by the stimulated taggant additives may be detected using a verification device and compared against authentic taggant information recorded in the database. If the taggant information detected by the verification device matches a recorded entry of authentic taggant information, the authenticity of the item may be verified.

### BRIEF DESCRIPTION OF THE DRAWINGS

The above and other advantages of the invention will be apparent upon consideration of the following detailed description, taken in conjunction with the accompanying drawings, in which like reference characters refer to like parts throughout, and in which:

FIGS. 1 and 2 are schematic diagrams of illustrative techniques for embedding taggant additives in an item or a substance used to make an item in accordance with the present invention;

FIG. 3 is a diagram of an illustrative technique for detecting taggant information from taggant additives embedded in an item or substance in accordance with the present invention;

FIG. 4 is a diagram of the emission of radiation by taggant additives in accordance with the present invention;

FIG. 5 is a diagram of an illustrative technique for affixing taggant additives to an item and detecting taggant information from taggant additives affixed to an item in accordance with the present invention;

FIG. 6 is a diagram of an illustrative technique for generating taggant information and recording the taggant information in a database in accordance with the present invention;

FIG. 7 is a diagram of an illustrative technique for verifying the authenticity of a tagged item using authentic taggant information recorded in a database in accordance with the present invention;

FIG. 8 is a flow chart of illustrative steps that may be involved in detecting and recording taggant information in accordance with the present invention; and

FIG. 9 is a flow chart of illustrative steps that may be involved in verifying the authenticity of a tagged item in accordance with the present invention.

### DETAILED DESCRIPTION OF THE INVENTION

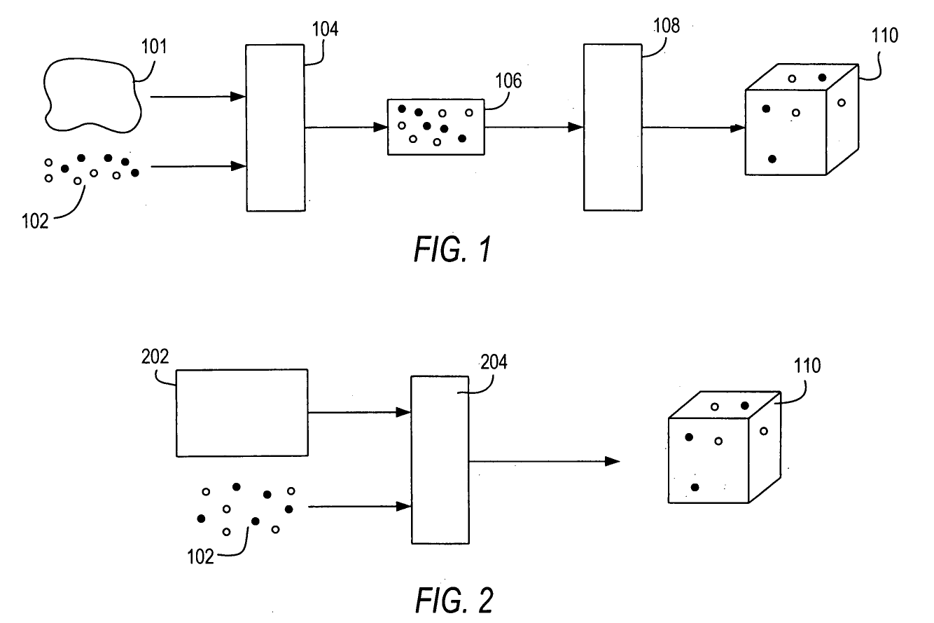

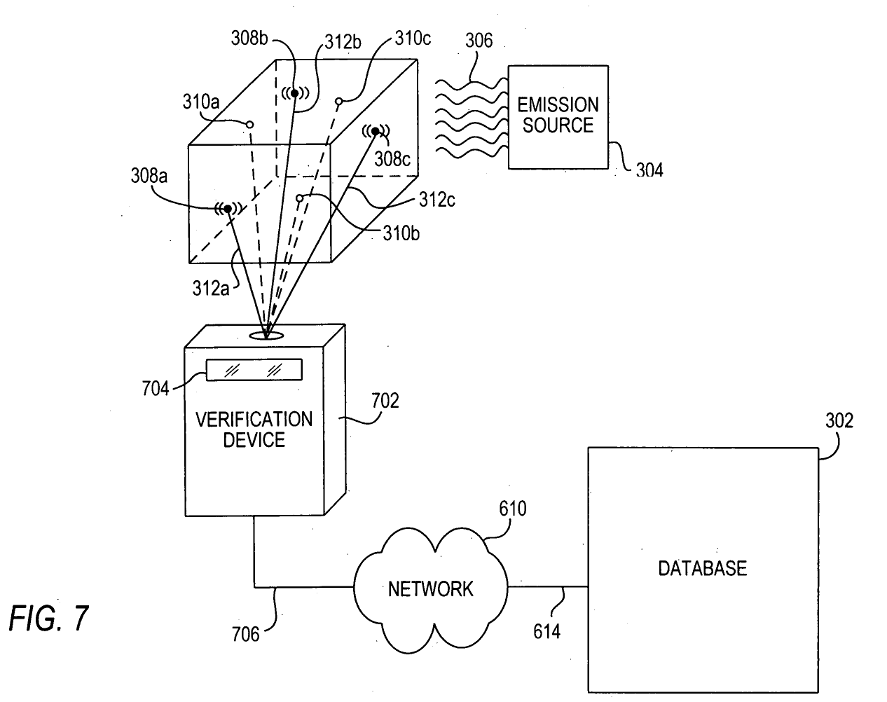

The invention will now be described with reference to FIGS. 1-9.

FIG. 1 shows material 101 being combined with taggant additives 102 to produce tagged substance 106. Material 101 may be any material that is used in a manufacturing process and which may be combined with taggant additives 102. For illustrative purposes, material 101 is discussed herein as being a plastic material. It will be understood, however, that the present invention may be used with any other natural or synthetic material (e.g., rubber, plaster, composites, etc.).

Taggant additives 102 may be one or more of any type of taggant additive used to tag an item or substance. For illustrative purposes, taggant additives 102 are disclosed herein as being microparticles. It will be understood, however, that any other type of taggant additive may be used in accordance with the present invention (e.g., pigments, dyes, etc.). Taggant additives 102 may include one or more types of different microparticle taggant additives—e.g., organic or inorganic phosphors, melamine, polarized particles, magnetic particles, thermo-sensitive particles, photo-sensitive particles, reflective particles, refractive particles, any other known microparticle used to tag an item, or any combination thereof.

In FIG. 1, mixing device 104 may be used to combine material 101 with taggant additives 102. Mixing device 104 may be any known device for combining taggant additives 102 with material 101 to produce tagged substance 106. In the illustrative example of FIG. 1, tagged substance 106 may be, for example, a tagged plastic resin. Mixing device 104 may include various components that are used for various processes (e.g., mixing, injection molding, rotomolding, blow molding, die casting, blending, extruding, etc.) in order to produce tagged substance 106 and to achieve as random as possible a distribution of taggant additives 102 in material 101. Although mixing device 104 is identified as a single device in FIG. 1, it will be understood that more than one device may be used to mix, blend, or extrude substance 106 or to perform any other process associated with combining taggant additives 102 with material 101 to produce tagged substance 106.

Substance 106 may be used to create tagged item 110 using manufacturing device 108. Manufacturing device 108 may be any known device or combination of devices used to manufacture tagged item 110—e.g., injection molding, rotomolding, blow molding, die casting, or extruding machinery, etc. Tagged item 110 may be any manufactured item having taggant additives 102. For the purposes of brevity and clarity, only one manufacturing device 108 is identified in FIG. 1. It will be understood that more than one device may be used to produce tagged item 110 from tagged substance 106.

Instead of tagging a substance (as in FIG. 1) in advance of the formation of an item from that substance, it may be desirable to combine a substance, such as an untagged plastic resin, with taggant additives 102 during the process of manufacturing item 110. For example, in FIG. 2 substance 202 may be combined with taggant additives 102 using device 204 to create tagged item 110. Device 204 may be used to perform the functions associated with both mixing device 104 and manufacturing device 108 of FIG. 1 (e.g., mixing, injection molding, rotomolding, blow molding, die casting, blending, extruding, etc.). It will be understood that more than one device may be used to produce tagged item 110 and that only one device is identified in FIG. 2 for the purposes of brevity and clarity.

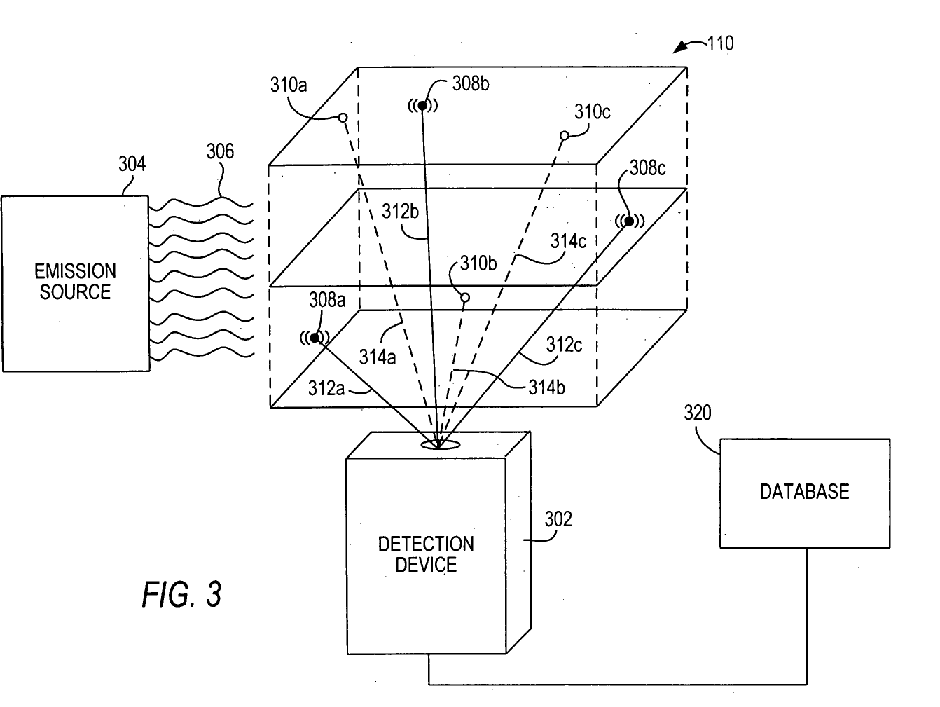

FIG. 3 shows a more detailed view of tagged item 110 having embedded taggant additives 102. In FIG. 3, item 110 includes two different types of taggant additives: taggant additive type 308 (dark colored in FIG. 3 for illustrative purposes) and taggant additive type 310 (light colored in FIG. 3 for illustrative purposes). It will be understood that any number of types of taggant additives may be used in accordance with the present invention. For the purposes of brevity and clarity, the invention is discussed herein using two types of taggant additives. Taggant additive types 308 and 310 preferably are distributed as randomly as possible throughout the solid material of tagged item 110. Taggant additive type 308 may include taggant additives 308a, 308b, 308c. Taggant additive type 310 may include taggant additives 310a, 310b, 310c.

Item 110 may be interrogated to determine the item's taggant information using, for example, one or more types of radiation or energy emission. In FIG. 3, emission source 304 is shown as emitting radiation or energy emission 306, which may stimulate one or more types of taggant additives embedded in item 110. The radiation or energy emission may be, for example, an optical emission, an X-ray emission, an infrared emission, a particulate or non-particulate emission, a direct or indirect emission, a target specific or general emission, or any other emission needed to stimulate the one or more types of embedded taggant additives.

Taggant additives may emit radiation or other energy in response to being stimulated by a particular type of radiation or energy emission. In the example of FIG. 3, the solid lines 312a, 312b, 312c originating at taggant additives 308a, 308b, 308c, respectively, illustrate radiation or other energy emissions that may be generated by stimulating taggant additives 310a, 310b, 310c using radiation or energy emission 306 or an alternative radiation or energy emission. The chemical composition of a given taggant additive may determine whether it is stimulated in response to a particular radiation or energy emission.

Taggant additives 310a, 310b, 310c may also be stimulated by a radiation or energy emission (e.g., radiation or energy emission 306 or an alternative type of radiation or energy emission). When stimulated, taggant additives 310a, 310b, 310c may emit radiation emissions 314a, 314b, 314c, respectively, which may be detected by detection device 302. For the purposes of brevity and clarity, the description below will focus primarily on radiation emissions 312a, 312b, 312c originating from taggant additives 308a, 308b, 308c, respectively. It will be understood, however, that any number of types of taggant additives may be embedded in item 110, each of which may emit radiation or other energy in response to being stimulated by one or more types of radiation or energy emission. Radiation or energy emissions 314a, 314b, and 314c are illustrative examples of emissions from an additional type of taggant additive being used in accordance with the present invention.

One or more energy emissions may be used to stimulate one or more types of taggant additives 308, 310. Simulated taggant additives may emit radiation emissions 312, 314, which may be detected by detection device(s) 302. It may be desirable to use more than one type of radiation or energy emission to stimulate more than one type of taggant additive. For example, a first type of radiation or energy emission may stimulate taggant additive type 308 while another type of radiation or energy emission may stimulate taggant additive type 310. It will be understood that more than one type of taggant additive may be stimulated by a single radiation or energy emission, or that more than one type of radiation or energy emission may be used to stimulate more than one type of taggant additive. It will also be understood that a single emission source may be capable of emitting more than one type of radiation or energy emission, or that multiple emission sources may be used to emit each type of radiation or energy emission. Also, multiple detection devices may be used to detect radiation or energy emissions from each type of taggant additive that is stimulated by each type of radiation or energy emission. Or, a single detection device may be used to detect radiation or energy emissions from more than one type of taggant additive. It will also be understood that a single device may be used to emit one or more radiation or energy emissions and to detect radiation or other energy from one or more taggant additives stimulated by the energy emissions. For the purposes of brevity and clarity, a single emission source 304 is shown in FIG. 3 as emitting a single radiation or energy emission 306, and a single detection device 302 is used to detect radiation or energy emissions. For purposes of brevity, radiation emissions or energy emissions used to stimulate the target object will be referred to hereinafter as “probe emissions,” while the radiation emissions or energy emissions from the target will be referred to as “target emissions.” Both probe emissions and target emissions can be radiation emissions or other types of energy emissions.

Probe emission 306 may stimulate one or more types of taggant additive (e.g., taggant additive types 308 and 310). Target emissions emitted by stimulated taggant additives may be detected by detection device(s) 302. Detection device(s) 302 may include any suitable component for detecting stimulated taggant additive radiation emissions. Once detected, taggant information based on the detected target emissions may be recorded in database 320. Taggant information may include, for example, information about the spatial arrangement of the taggant additives being stimulated by a particular probe emission (e.g., probe emission 306). In the illustrated example, detection device(s) 302 may determine the spatial arrangement of taggant additives 308a, 308b, 308c based on the target emissions of these taggant additives when stimulated. The taggant information may include, for example, a digital image depicting the spatial arrangement of taggants 308a, 308b, 308c.

The spatial arrangement of the taggant additives may be determined using known components and methods for recording taggant additive target emissions that have been detected using detection device(s) 302. For example, detection device(s) 302 may be configured to record target emissions and to generate a graphical representation of the spatial arrangement of the stimulated taggant additives.

Other types of taggant information may be stored in directory 320. For example, taggant information may also include information about the target emissions emitted by the stimulated taggant additives (e.g., the intensity of the target emissions, the polarization of the target emissions, the various angles at which the target emissions are emitted, spectral distribution of the target emissions, etc.). Although the detection of target emissions is described as being the result of stimulation (e.g., fluorescence) of the taggant additives by probe emission 306, target emissions may also be emitted by, for example, the reflection or refraction of the probe emissions by the taggant additives.

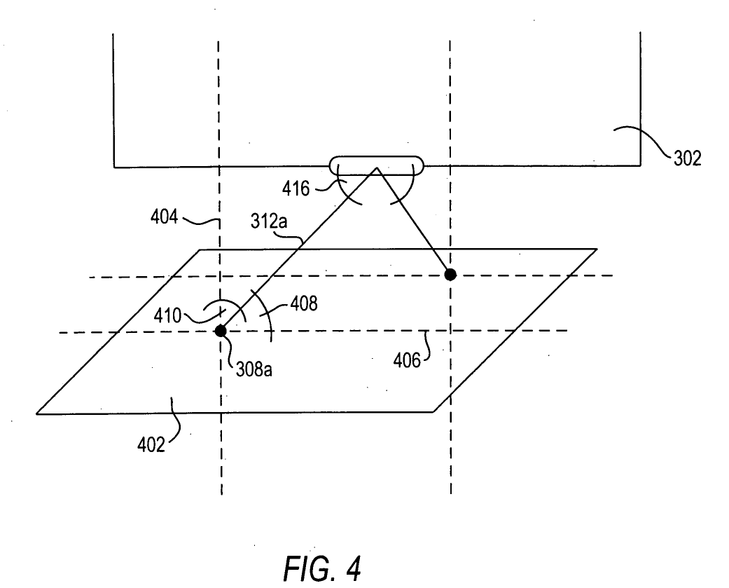

In one embodiment, detection device(s) 302 may determine information about the reflectivity of target emissions emitted by one or more stimulated taggant additives. For example, FIG. 4 shows taggant additive 308a embedded in plane 402 of an item. Plane 402 includes a vertical axis 404 and horizontal axis 406, which may be determined by detection device(s) 302 based on the positioning of detection device(s) 302 with respect to plane 402. Taggant additive 308a is emitting target emission 312a. Target emission 312a is producing emission angles with respect to the vertical and horizontal axes of plane 402. For example, angle 408 describes the emission angle at which target emission 312a is emitted with respect to horizontal axis 406. Angle 410 describes the emission angle at which target emission 312a is emitted with respect to vertical axis 404. Angle 416 describes the emission angle at which target emission 312a strikes the plane of detection device(s) 302. These emission angle measurements, with respect to both the detection device or an axis associated with plane 402, may be recorded as taggant information.

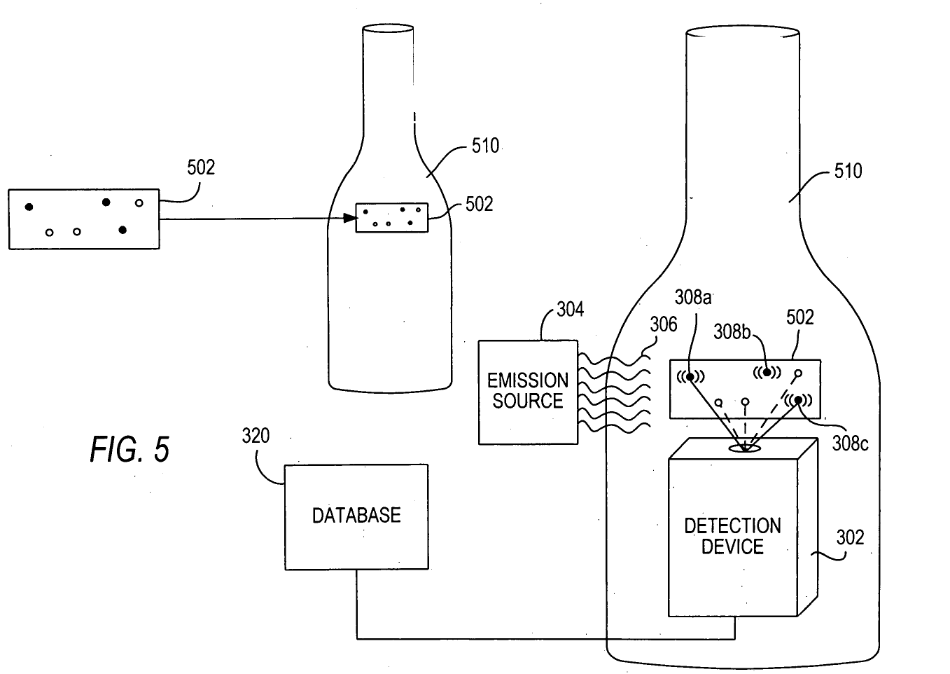

Taggant information may also be detected from taggant additives that are affixed to an item. In FIG. 5, taggant additives may be combined with a substance to make tagged label 502. Tagged label 502 may be affixed to item 510 using an adhesive. This technique of affixing tagged label 502 to item 510 may be preferred to embedding taggant additives in an item if the item is manufactured from a material that does not easily allow taggant additives to be embedded or detected (e.g., glass, wood, lead, etc.).

In FIG. 5, detection device(s) 302 may be used to interrogate taggant label 502 using probe emission 306. As discussed in connection with FIG. 3, taggant additives 308a, 308b, 308c may be stimulated by probe emission 306 using emission source 304. Stimulated taggant additives may emit target emissions, which may be detected using detection device(s) 302. As discussed in connection with FIG. 3, detection device(s) 302 may include known components for detecting target emissions from stimulated taggant additives and recording taggant information in database 320 based on the detected target emissions.

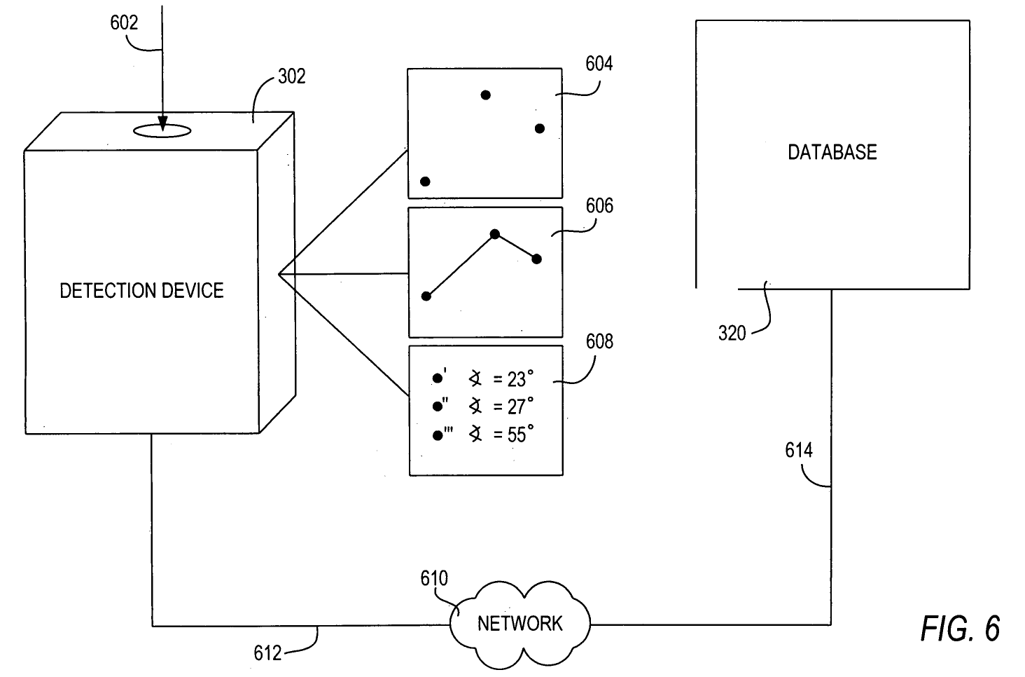

In FIG. 6, target emission information 602 is detected by detection device(s) 302. As discussed above, detection device(s) 302 may detect target emissions and generate taggant information 604, 606, 608 that describes information about the taggant additives (e.g., their spatial arrangement) or the taggant additive target emissions (e.g., their intensity). In one example, taggant information 604 shows a digital image of the spatial arrangement of the taggant additives that emitted radiation when stimulated by a particular type of probe emission. In another example, taggant information 606 shows a similar digital image in which the stimulated taggant additives are connected with a line. The digital images of the taggant information may be generated using, for example, any combination of known hardware and software components for detecting target emissions and generating a digital image based on the target emissions detected.

Taggant information may also be information that describes the reflectivity of stimulated taggant additives. For example, taggant information 608 shows radiation emission angle measurements which may be, for example, measurements associated with the target emission of a particular taggant additive (e.g., emission angle with respect to a horizontal axis, emission angle with respect to a vertical axis, emission angle with respect to the detection device, etc.). Or, the emission angle measurements may be a common emission measurement for each stimulated taggant additive that emits target emissions.

It will be understood that the foregoing examples are merely illustrative of the various types of taggant information that may be recorded in database 320 based on the target emissions detected. Any information that may be determined based on the detection of the target emissions may be recorded as taggant information. In a further example, information about the intensity of a target emissions may also be recorded. Combinations of types of taggant information may also be recorded (e.g., spatial arrangement information with emission intensity information, etc.).

Taggant information may be recorded in database 320 and associated with a item identifier that identifies the particular item being interrogated (e.g., tagged item 110). The item identifier may be e.g., a serial number, a bar code number, or other number that is specific to a particular tagged item. It may be desirable to print the item identifier on the tagged item in an alphanumeric format (e.g., a serial number) or to otherwise physically associate the item identifier with the tagged item (e.g., using a machine-readable format such as a bar code, a radio frequency identification device, etc.). In the tagged label embodiment of FIG. 5, the tagged label could be the same label that bears the bar code or other identifier. In another embodiment, the identifier could itself be a different emission pattern or refractive/reflective index that is read using a different emission source and detector than the taggant information. The database could be scanned for this different emission pattern or refractive/reflective index, and if the different emission pattern or refractive/reflective index is found, taggant information associated with it can be recalled.

Database 320 may reside on a fixed storage device, such as a database server, and may be accessed remotely over a network (e.g., the Internet). Alternatively, database 320 may be recorded on a removable storage device, which may be physically sent to a remote site and used for verifying the taggant information of received items. Database 320 may one or more of any available medium for storing information. Database 320 may include software for implementing a rationally related database architecture (e.g., a database implemented using Oracle® technology developed by Oracle Corporation of Redwood City, Calif., a Microsoft Access™database or a database available from Microsoft SQL Server™, both available from Microsoft Corporation of Redmond, Wash., etc.).

It may be desirable for additional information about a tagged item to be recorded in database 320 and associated with the recorded taggant information. For example, on or more of the item's type, source of manufacture, lot, price, chain of custody or distribution, or any other information may be recorded in database 320 and associated with an item's recorded taggant information. Information about the interrogation that yielded the recorded taggant information (e.g., the type(s) of probe emission(s) used, the positioning of detection device 302 with respect to the item, etc.) may also be recorded and associated with the recorded taggant information and item identifier. With this information, the taggant information may not only verify the authenticity of an item, but may also be used as a means for precisely identifying items in shipping, tracking, point-of-sale transactions, and other inventory management applications. While various items of information may be stored in database 320, not all detection systems will necessarily use all of the data. For example, a manufacturer may have access to all of the data, while a distributor may have access to only a portion of the data.

Detection device(s) 302 may transmit taggant information 604, 606, 608 to database 320 via network 610 using communication paths 612 and 614. Network 610 may be a local- or wide-area network (e.g., the Internet, an intranet, a virtual private network, etc.) and may support any combination of wired, wireless, or optical communications. Communication paths 612 and 614 may be any suitable wired or wireless communications path. A combination of wired and wireless communication paths may also be used.

Once authentic taggant information has been recorded in database 320, the recorded authentic taggant information may be used to verify the authenticity of a tagged item. In one scenario, it may be desirable to identify and verify the authenticity of a tagged item if the tagged item is returned to the manufacturer because it is defective. In another scenario, it may be desirable to identify or verify the authenticity of a shipment of tagged items received by a recipient. In both cases, a verification device may be used, in conjunction with the authentic taggant information recorded in database 320, to identify a tagged item or to verify the authenticity of a tagged item.

The verification device may be configured to identify a tagged item, or to verify the authenticity of a tagged item, using the same processes and equipment (as shown in FIG. 3) for initially detecting taggant information (e.g., by interrogating tagged items using one or more probe emissions and detecting target emissions by taggant additives that are stimulated by the one or more probe emissions). In one approach, the item identifier (e.g., the item's serial number) may be used to access the recorded taggant information for a particular item. The item identifier may be e.g., a number that is printed on the item and entered manually to identify the item, a machine-readable bar code that is affixed to or printed on an item and scanned to identify the item, a machine-readable radio frequency device that emits a radio frequency signal encoded with identification information that identifies a particular item, etc. Once the item has been identified, the recorded taggant information for the item may be compared to taggant information detected using verification device(s) 702.

Verification device may include hardware and software for comparing the detected taggant information with the authentic taggant information recorded in database 320. In one approach, known software may be implemented on verification device 702 (or a separate device, not shown) and used to compare the taggant information recorded in database 320 with taggant information detected using verification device 702. If the software determines a match between the recorded taggant information and the detected taggant information, the authenticity of the tagged item may be verified.

In another approach, comparing recorded taggant information with taggant information detected using verification device(s) 702 may include recalling the recorded taggant information and representing the recorded taggant information using a hard-wired logic-based matrix. The matrix may assign a numeric value (e.g., “1” or “0”) to each matrix gate in order to indicate whether a target emission was detected at each particular position in the matrix that correspond to locations throughout the tagged item. In such an approach, target emissions detected by detection device(s) 302 may be designated a logical value of “1” within the matrix at a matrix gate that corresponds to the location of a taggant additive's placement in the tagged item.

Once the hard-wired matrix has been configured to represent the relevant taggant information recorded in database 320, a similar matrix may be configured based on the actual target emissions and taggant information detected using verification device(s) 702. The two matrices may then be compared using, for example, an exclusive-NOR logic scheme, which yields a value of “1” for each matrix item that matches. If the matrices match (e.g., in the exclusive-NOR example, if the comparison matrix is all “1s”), the authenticity of the tagged item may be verified.

In another approach, the item identifier need not be used to identify or verify the authenticity of a tagged item. Instead, verification device(s) 702 may be used to detect target emissions 312a, 312b, 312c, and the detected taggant information may be transmitted to database 320 and compared to each entry of the authentic taggant information recorded in database 320. If a match is found, the tagged item may be precisely identified and its authenticity, therefore, verified. In one such embodiment, as discussed above, two patterns can be recorded for an item, and the database can be searched for one of the patterns which when found can be used as an identifier to recall the other pattern for verification.

Verification device(s) 702 may indicate that the interrogated item is authentic, for example by illuminating a verification indicator 704. The verification device may indicate whether the item is or is not authentic (e.g., by illuminating verification indicator 704 the color-green when a tagged item is authentic and a match is found in the database, and illuminating verification indication 704 the color red when a tagged item is not authentic and no match is found in the database, etc.).

In order to verify the authenticity of a tagged item, it may be necessary to position detection device(s) 302 and verification device(s) 702 in a common and precise orientation with respect to tagged item 110. This will ensure that the taggant information generated using verification device(s) 702 will match as closely as possible the recorded taggant information that was generated using detection device(s) 302. This may be accomplished, for example, by providing some mark or indication in the exterior surface of an item to indicate a precise orientation with respect to the item at which to interrogate the item using detection device(s) 302 and verification device(s) 702. Or, the stored information retrieved by the item identifier may indicate the required orientation. Alternatively, taggant information for an entire tagged item may be detected by detection device(s) 302 and verification device(s) 702 to facilitate the matching and verification process.

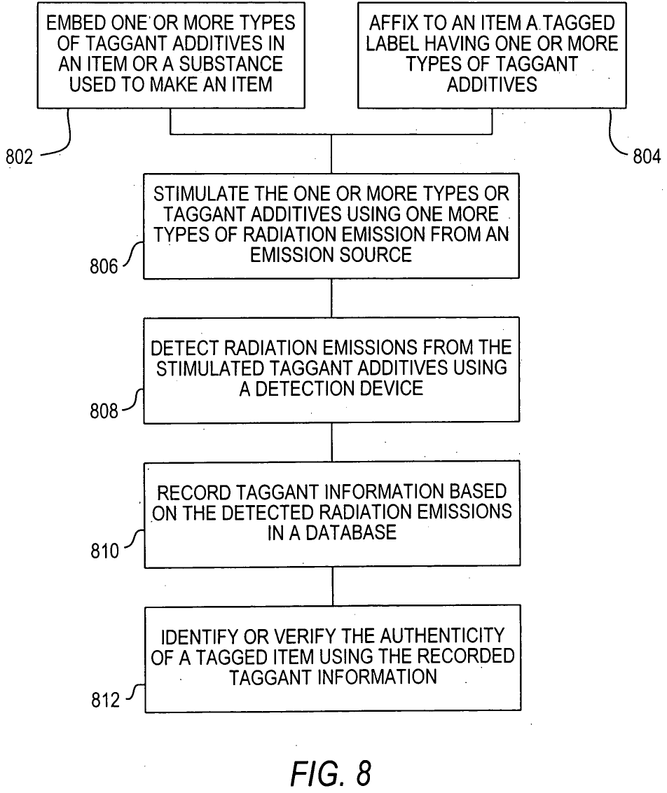

A flow chart 800 of illustrative steps that may be involved in detecting and storing taggant information for a tagged item is shown in FIG. 8. At step 802, one or more taggant additives may be embedded in an item or a substance used to make an item. The one or more taggant additives may be incorporated into a substance, such as a plastic resin, that is used to manufacture an item. Or, the one or more taggant additives may be combined with an untagged plastic resin during the manufacturing process. In another embodiment, as shown at step 804, one of more taggant additives may be combined with a substance and affixed to a finished item using an adhesive.

At step 806, a tagged item or tagged label may be interrogated using one or more types of probe emissions. The one or more types of probe emissions may stimulate one or more of the taggant additives embedded in or affixed to the item, which will cause the one or more stimulated taggant additives to emit target emissions. At step 808, the target emissions emitted by the one or more stimulated taggant additives may be detected using a detection device.

At step 810 taggant information that describes information about the taggant additives embedded in, or affixed to, an item may be recorded in a database. Taggant information may be, for example, information about the spatial arrangement of taggant additives stimulated by a particular type of energy emission, the intensity of radiation emissions emitted by stimulated taggants, etc. The database may be a relational database that allows a given tagged item's taggant information to be associated with an item identifier that distinctly identifies the tagged item (e.g., a database key, a serial number, etc.). Other information may also be recorded in the database and associated with the item identifier and taggant information at step 812. For example a tagged item's type, origin of manufacture, lot, price, etc. may be recorded in the database and associated with the item identifier and taggant information for a tagged item. Information about the interrogation that yielded the recorded taggant information (e.g., the type(s) of energy emission(s) used, the positioning of detection device 302 with respect to the item, etc.) may also be recorded and associated with the recorded taggant information and item identifier. With such information recorded in the database, a tagged item's taggant information may be used as a bar code and used in connection with inventory processes and controls in addition to verifying the authenticity of tagged items. At step 814, the tagged item may be identified, or the authenticity of the tagged item may be verified, using the taggant information recorded in the database.

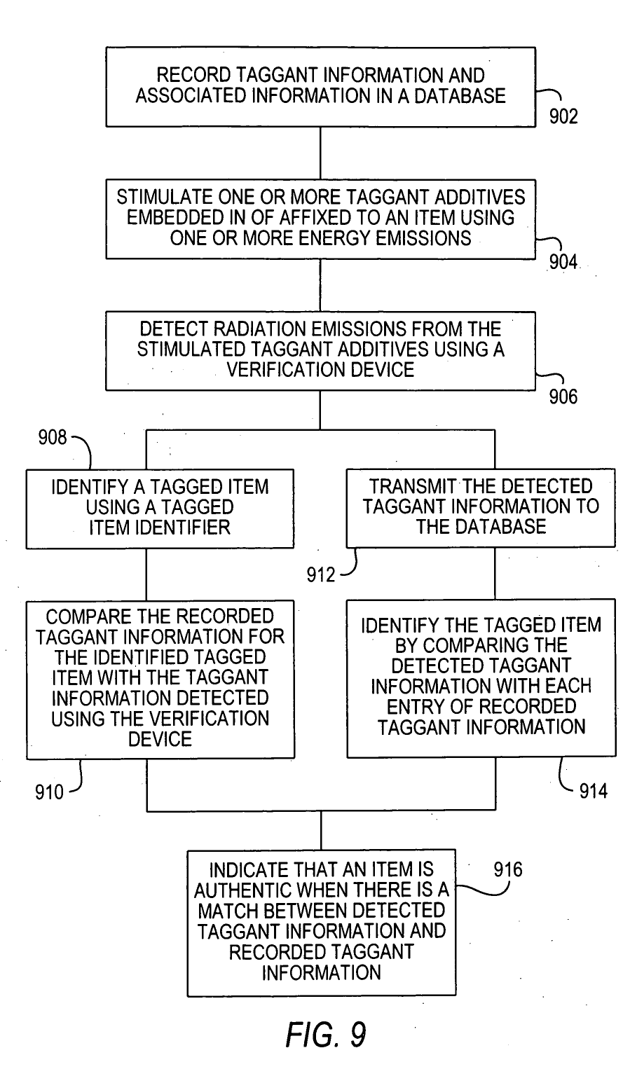

A flow chart 900 of illustrative steps that may be involved in verifying the authenticity of a tagged item is shown in FIG. 9. At step 902, taggant information that describes information about the taggant additives embedded in, or affixed to, an item may be recorded in a database. Other related information (e.g., an item identifier) may also be recorded and associated with the recorded taggant information. At step 904, a tagged item may be interrogated using one or more types of probe emissions. The one or more types of probe emissions may stimulate one or more types of taggant additives embedded in or affixed to the item. Simulated taggant additives may emit target emissions. At step 906, the target emissions emitted by the one or more stimulated taggant additives may be detected using a verification device.

The taggant information detected using the verification device at step 906 may be compared to authentic taggant information recorded in the database in order to identify, or verify the authenticity of, a tagged item. At step 908, the tagged item may be identified using an item identifier (e.g., a serial number, a bar code, a radio frequency transmission device, etc.), and at step 910 the authentic taggant information recorded in the database for the identified tagged item may be compared to the taggant information detected by the verification device.

Alternatively, a tagged item may be identified, and its authenticity therefore verified, by transmitting the taggant information detected by the verification device to the database at step 914. At step 916, the database may be used to compare the detected taggant information to each entry of authentic taggant information recorded in the database. If the taggant information detected by the verification device matches recorded taggant information, the item may be identified and its authenticity verified. If no match is found, the item may not be authentic. At step 912, the verification device may indicate whether the detection device is or is not authentic.

It will be understood that the foregoing is only illustrative of the principles of the invention, and that various modifications can be made by those skilled in the art without departing from the scope and spirit of the invention, and the present invention is limited only by the claims that follow.

1. A method for detecting and storing taggant information for a tagged item based on one or more taggant additives that are embedded in or affixed to the tagged item, the method comprising:
interrogating the tagged item using one or more probe emissions;
detecting target emissions from one or more taggant additives that are stimulated by the one or more probe emissions; and
recording in a database taggant information based on the detected radiation emissions.

2. The method of claim 1, further comprising:
associating additional information with the recorded taggant information.

3. The method of claim 1, further comprising:
identifying the tagged item using a verification device and the recorded taggant information.

4. The method of claim 3, wherein identifying the tagged item further comprises:
interrogating the tagged item using the one or more probe emissions;
detecting target emissions from the one or more taggant additives that are stimulated by the one or more probe emissions; and
comparing the detected taggant information to taggant information recorded in the database.

5. The method of claim 4, further comprising:
indicating that an item is authentic when there is a match between the taggant information detected and the recorded taggant information.

6. The method of claim 1, wherein the taggant information includes information about the spatial arrangement of the one or more taggant additives stimulated by the one or more probe emissions.

7. The method of claim 6, wherein the taggant information is a digital image of the one or more taggant additives stimulated by the one or more probe emissions.

8. The method of claim 1, wherein the taggant information includes information about the reflectivity of the one or more taggant additives stimulated by the one or more probe emissions.

9. The method of claim 1, wherein the taggant information includes information about the intensity of the target emission emitted by the one or more taggant additives in response to being stimulated by the one or more probe emissions.

10. The method of claim 1, wherein the taggant information includes information about the polarization of the target emission emitted by the one or more taggant additives in response to being stimulated by the one or more probe emissions.

11. The method of claim 1, wherein the taggant information includes information about the emission angle of the target emission emitted by the one or more taggant additives in response to being stimulated by the one or more probe emissions.

12. The method of claim 1, wherein the taggant information includes information about the spectral distribution of the target emission emitted by the one or more taggant additives in response to being stimulated by the one or more probe emissions.

13. The method of claim 1, wherein the target emissions are emitted by fluorescence.

14. The method of claim 1, wherein the target emissions are emitted by reflection.

15. The method of claim 1, wherein the target emissions are emitted by refraction.

16. A method for identifying or verifying the authenticity of a tagged item, wherein taggant information that describes information about one or more taggant additives embedded in or affixed to the tagged item is recorded in a database, and wherein an item identifier is recorded in the database and associated with the taggant information, the method comprising:
interrogating the tagged item using one or more probe emissions;
detecting one or more target emissions from one or more taggant additives that are stimulated by the one or more probe emissions; and
comparing the detected taggant information with taggant information recorded in the database.

17. The method of claim 16, further comprising:
identifying the tagged item using the item identifier; and
comparing the recorded taggant information associated with the item identifier with the detected taggant information.

18. The method of claim 17, further comprising:
verifying the authenticity of the tagged item by matching the detected taggant information with taggant information recorded in the database.

19. The method of claim 18, further comprising:
indicating that an item is authentic when there is a match between the taggant information detected and the recorded taggant information.

20. The method of claim 16, further comprising:
identifying the tagged item by matching the detected taggant information with taggant information recorded in the database.

21. The method of claim 16, further comprising:
associating additional information with the recorded taggant information and the recorded item identifier.

22. The method of claim 16, wherein the taggant information includes information about the spatial arrangement of the one or more taggant additives stimulated by the one or more probe emissions.

23. The method of claim 22, wherein the taggant information is a digital image of the one or more taggant additives stimulated by the one or more probe emissions.

24. The method of claim 15, wherein the taggant information includes information about the reflectivity of the one or more taggant additives stimulated by the one or more probe emissions.

25. The method of claim 16, wherein the taggant information includes information about the intensity of the target emission emitted by the one or more taggant additives in response to being stimulated by the one or more probe emissions.

26. The method of claim 16, wherein the taggant information includes information about the polarization of the target emission emitted by the one or more taggant additives in response to being stimulated by the one or more probe emissions.

27. The method of claim 16, wherein the taggant information includes information about the emission angle of the target emission emitted by the one or more taggant additives in response to being stimulated by the one or more probe emissions.

28. The method of claim 16, wherein the taggant information includes information about the spectral distribution of the target emission emitted by the one or more taggant additives in response to being stimulated by the one or more probe emissions.

29. The method of claim 16, wherein the target emissions are emitted by fluorescence.

30. The method of claim 16, wherein the target emissions are emitted by reflection.

31. The method of claim 16, wherein the target emissions are emitted by refraction.

32. A system for detecting and storing taggant information for a tagged item based on one or more taggant additives that are embedded in or affixed to the tagged item, the system comprising:
an emission source for interrogating the tagged item using one or more probe emissions;
a detection device for detecting target emissions from one or more taggant additives that are stimulated by the one or more probe emissions; and
a database for recording taggant information based on the detected target emissions.

33. The system of claim 32, wherein additional information about the tagged item is recorded and associated with the recorded taggant information.

34. The system of claim 32, further comprising:
a verification device for identifying the tagged item using the recorded taggant information.

35. The system of claim 34, wherein the verification device is configured to:
interrogate the tagged item using the one or more probe emissions;
detect target emissions from the one or more taggant additives that are stimulated by the one or more probe emissions; and
comparing the detected taggant information to taggant information recorded in the database.

36. The system of claim 35, wherein the verification device is configured to:
indicate that an item is authentic when there is a match between the taggant information detected and the recorded taggant information.

37. The system of claim 32, wherein the taggant information includes information about the spatial arrangement of the one or more taggant additives stimulated by the one or more probe emissions.

38. The system of claim 37, wherein the taggant information is a digital image of the one or more taggant additives stimulated by the one or more probe emissions.

39. The system of claim 32, wherein the taggant information includes information about the reflectivity of the one or more taggant additives stimulated by the one or more probe emissions.

40. The system of claim 32, wherein the taggant information includes information about the intensity of the target emission emitted by the one or more taggant additives in response to being stimulated by the one or more probe emissions.

41. The system of claim 32, wherein the taggant information includes information about the polarization of the target emission emitted by the one or more taggant additives in response to being stimulated by the one or more probe emissions.

42. The system of claim 32, wherein the taggant information includes information about the emission angle of the target emission emitted by the one or more taggant additives in response to being stimulated by the one or more probe emissions.

43. The system of claim 32, wherein the taggant information includes information about the spectral distribution of the target emission emitted by the one or more taggant additives in response to being stimulated by the one or more probe emissions.

44. The system of claim 32, wherein the target emissions are emitted by fluorescence.

45. The system of claim 32, wherein the target emissions are emitted by reflection.

46. The system of claim 32, wherein the target emissions are emitted by refraction.

47. A system for identifying or verifying the authenticity of a tagged item, wherein taggant information that describes information about one or more taggant additives embedded in or affixed to the tagged item is recorded in a database, and wherein an item identifier is recorded in the database and associated with the taggant information, the system comprising:
an emission source for interrogating the tagged item using one or more probe emissions; and
a verification device for detecting target emissions from one or more taggant additives that are stimulated by the one or more probe emissions, wherein the verification device is further configured to compare the detected taggant information with taggant information recorded in the database.

48. The system of claim 47, wherein the verification device is further configured to:
identify the tagged item using the item identifier; and
compare the recorded taggant information associated with the item identifier to the taggant information detected using the verification device.

49. The system of claim 48, wherein the verification device is further configured to:
verify the authenticity of the tagged item by matching the detected taggant information with taggant information recorded in the database.

50. The system of claim 49, wherein the verification device is further configured to:
indicate that an item is authentic when there is a match between the taggant information detected and the recorded taggant information.

51. The system of claim 47, wherein the verification device is further configured to:
identify the tagged item by matching the detected taggant information with taggant information recorded in the database.

52. The system of claim 47, wherein additional information about a tagged item is recorded and associated with the recorded taggant information.

53. The system of claim 47, wherein the taggant information includes information about the spatial arrangement of the one or more taggant additives stimulated by the one or more probe emissions.

54. The system of claim 53, wherein the taggant information is a digital image of the one or more taggant additives stimulated by the one or more probe emissions.

55. The system of claim 47, wherein the taggant information includes information about the reflectivity of the one or more taggant additives stimulated by the one or more probe emissions.

56. The system of claim 47, wherein the taggant information includes information about the intensity of the target emission emitted by the one or more taggant additives in response to being stimulated by the one or more probe emissions.

57. The system of claim 47, wherein the taggant information includes information about the polarization of the target emission emitted by the one or more taggant additives in response to being stimulated by the one or more probe emissions.

58. The system of claim 47, wherein the taggant information includes information about the emission angle of the target emission emitted by the one or more taggant additives in response to being stimulated by the one or more probe emissions.

59. The system of claim 47, wherein the taggant information includes information about the spectral distribution of the target emission emitted by the one or more taggant additives in response to being stimulated by the one or more probe emissions.

60. The system of claim 47, wherein the target emissions are emitted by fluorescence.

61. The system of claim 47, wherein the target emissions are emitted by reflection.

62. The system of claim 47, wherein the target emissions are emitted by refraction.

63. A method for detecting and storing taggant information for a tagged item based on one or more taggant additives that are embedded in or affixed to the tagged item, the method comprising:
interrogating the tagged item using one or more probe emissions;
detecting target emissions from one or more taggant additives that are stimulated by the one or more probe emissions; and
recording taggant information based on the detected radiation emissions.

64. The method of claim 63, further comprising:
associating additional information with the recorded taggant information.

65. The method of claim 63, further comprising:
identifying the tagged item using a verification device and the recorded taggant information.

66. The method of claim 65, wherein identifying the tagged item further comprises:
interrogating the tagged item using the one or more probe emissions;
detecting target emissions from the one or more taggant additives that are stimulated by the one or more probe emissions; and
comparing the detected taggant information to the recorded taggant information.

67. The method of claim 66, further comprising:
indicating that an item is authentic when there is a match between the taggant information detected and the recorded taggant information.

68. The method of claim 63, wherein the taggant information includes information about the spatial arrangement of the one or more taggant additives stimulated by the one or more probe emissions.

69. The method of claim 68, wherein the taggant information is a digital image of the one or more taggant additives stimulated by the one or more probe emissions.

70. The method of claim 63, wherein the taggant information includes information about the reflectivity of the one or more taggant additives stimulated by the one or more probe emissions.

71. The method of claim 63, wherein the taggant information includes information about the intensity of the target emission emitted by the one or more taggant additives in response to being stimulated by the one or more probe emissions.

72. The method of claim 63, wherein the taggant information includes information about the polarization of the target emission emitted by the one or more taggant additives in response to being stimulated by the one or more probe emissions.

73. The method of claim 63, wherein the taggant information includes information about the emission angle of the target emission emitted by the one or more taggant additives in response to being stimulated by the one or more probe emissions.

74. The method of claim 63, wherein the taggant information includes information about the spectral distribution of the target emission emitted by the one or more taggant additives in response to being stimulated by the one or more probe emissions.

75. The method of claim 63, wherein the target emissions are emitted by fluorescence.

76. The method of claim 63, wherein the target emissions are emitted by reflection.

77. The method of claim 63, wherein the target emissions are emitted by refraction.

78. A method for identifying or verifying the authenticity of a tagged item, wherein taggant information that describes information about one or more taggant additives embedded in or affixed to the tagged item is recorded, and wherein an item identifier is recorded and associated with the taggant information, the method comprising:
interrogating the tagged item using one or more probe emissions;
detecting one or more target emissions from one or more taggant additives that are stimulated by the one or more probe emissions; and
comparing the detected taggant information with the recorded taggant information.

79. The method of claim 78, further comprising:
identifying the tagged item using the item identifier; and
comparing the recorded taggant information associated with the item identifier with the detected taggant information.

80. The method of claim 79, further comprising:
verifying the authenticity of the tagged item by matching the detected taggant information with the recorded taggant information.

81. The method of claim 80, further comprising:
indicating that an item is authentic when there is a match between the taggant information detected and the recorded taggant information.

82. The method of claim 78, further comprising:
identifying the tagged item by matching the detected taggant information with the recorded taggant information.

83. The method of claim 78, further comprising:
associating additional information with the recorded taggant information and the recorded item identifier.

84. The method of claim 78, wherein the taggant information includes information about the spatial arrangement of the one or more taggant additives stimulated by the one or more probe emissions.

85. The method of claim 84, wherein the taggant information is a digital image of the one or more taggant additives stimulated by the one or more probe emissions.

86. The method of claim 78, wherein the taggant information includes information about the reflectivity of the one or more taggant additives stimulated by the one or more probe emissions.

87. The method of claim 78, wherein the taggant information includes information about the intensity of the target emission emitted by the one or more taggant additives in response to being stimulated by the one or more probe emissions.

88. The method of claim 78, wherein the taggant information includes information about the polarization of the target emission emitted by the one or more taggant additives in response to being stimulated by the one or more probe emissions.

89. The method of claim 78, wherein the taggant information includes information about the emission angle of the target emission emitted by the one or more taggant additives in response to being stimulated by the one or more probe emissions.

90. The method of claim 78, wherein the taggant information includes information about the spectral distribution of the target emission emitted by the one or more taggant additives in response to being stimulated by the one or more probe emissions.

91. The method of claim 78, wherein the target emissions are emitted by fluorescence.

92. The method of claim 78, wherein the target emissions are emitted by reflection.

93. The method of claim 78, wherein the target emissions are emitted by refraction.

94. A system for detecting and storing taggant information for a tagged item based on one or more taggant additives that are embedded in or affixed to the tagged item, the system comprising:
an emission source for interrogating the tagged item using one or more probe emissions;
a detection device for detecting target emissions from one or more taggant additives that are stimulated by the one or more probe emissions; and
a medium for recording taggant information based on the detected target emissions.

95. The system of claim 94, wherein additional information about the tagged item is recorded and associated with the recorded taggant information.

96. The system of claim 94, further comprising:
a verification device for identifying the tagged item using the recorded taggant information.

97. The system of claim 96, wherein the verification device is configured to:
interrogate the tagged item using the one or more probe emissions;
detect target emissions from the one or more taggant additives that are stimulated by the one or more probe emissions; and
comparing the detected taggant information to the recorded taggant information.

98. The system of claim 97, wherein the verification device is configured to:
indicate that an item is authentic when there is a match between the taggant information detected and the recorded taggant information.

99. The system of claim 94, wherein the taggant information includes information about the spatial arrangement of the one or more taggant additives stimulated by the one or more probe emissions.

100. The system of claim 99, wherein the taggant information is a digital image of the one or more taggant additives stimulated by the one or more probe emissions.

101. The system of claim 94, wherein the taggant information includes information about the reflectivity of the one or more taggant additives stimulated by the one or more probe emissions.

102. The system of claim 94, wherein the taggant information includes information about the intensity of the target emission emitted by the one or more taggant additives in response to being stimulated by the one or more probe emissions.

103. The system of claim 94, wherein the taggant information includes information about the polarization of the target emission emitted by the one or more taggant additives in response to being stimulated by the one or more probe emissions.

104. The system of claim 94, wherein the taggant information includes information about the emission angle of the target emission emitted by the one or more taggant additives in response to being stimulated by the one or more probe emissions.

105. The system of claim 94, wherein the taggant information includes information about the spectral distribution of the target emission emitted by the one or more taggant additives in response to being stimulated by the one or more probe emissions.

106. The system of claim 94, wherein the target emissions are emitted by fluorescence.

107. The system of claim 94, wherein the target emissions are emitted by reflection.

108. The system of claim 94, wherein the target emissions are emitted by refraction.

109. A system for identifying or verifying the authenticity of a tagged item, wherein taggant information that describes information about one or more taggant additives embedded in or affixed to the tagged item is recorded, and wherein an item identifier is recorded and associated with the recorded taggant information, the system comprising:
an emission source for interrogating the tagged item using one or more probe emissions; and
a verification device for detecting target emissions from one or more taggant additives that are stimulated by the one or more probe emissions, wherein the verification device is further configured to compare the detected taggant information with recorded taggant information.

110. The system of claim 109, wherein the verification device is further configured to:
identify the tagged item using the item identifier; and
compare the recorded taggant information associated with the item identifier to the taggant information detected using the verification device.

111. The system of claim 110, wherein the verification device is further configured to:
verify the authenticity of the tagged item by matching the detected taggant information with the recorded taggant information.

112. The system of claim 111, wherein the verification device is further configured to:
indicate that an item is authentic when there is a match between the taggant information detected and the recorded taggant information.

113. The system of claim 109, wherein the verification device is further configured to:
identify the tagged item by matching the detected taggant information with recorded taggant information.

114. The system of claim 109, wherein additional information about a tagged item is recorded and associated with the recorded taggant information.

115. The system of claim 109, wherein the taggant information includes information about the spatial arrangement of the one or more taggant additives stimulated by the one or more probe emissions.

116. The system of claim 115, wherein the taggant information is a digital image of the one or more taggant additives stimulated by the one or more probe emissions.

117. The system of claim 109, wherein the taggant information includes information about the reflectivity of the one or more taggant additives stimulated by the one or more probe emissions.

118. The system of claim 109, wherein the taggant information includes information about the intensity of the target emission emitted by the one or more taggant additives in response to being stimulated by the one or more probe emissions.

119. The system of claim 109, wherein the taggant information includes information about the polarization of the target emission emitted by the one or more taggant additives in response to being stimulated by the one or more probe emissions.

120. The system of claim 109, wherein the taggant information includes information about the emission angle of the target emission emitted by the one or more taggant additives in response to being stimulated by the one or more probe emissions.

121. The system of claim 109, wherein the taggant information includes information about the spectral distribution of the target emission emitted by the one or more taggant additives in response to being stimulated by the one or more probe emissions.

122. The system of claim 109, wherein the target emissions are emitted by fluorescence.

123. The system of claim 109, wherein the target emissions are emitted by reflection.

124. The system of claim 109, wherein the target emissions are emitted by refraction.
